(19) United States
(12) Patent Application Publication
(10) Pub. No.: US 2026/0365461 A1
(43) Pub. Date: Nov. 19, 2026

(54) DIGGING HOPPER AND CARGO UNLOADING AUTOMATION METHOD USING SAME

(71) Applicant: CJ LOGISTICS CORPORATION, Seoul (KR)

(72) Inventors: Seung Mo KIM, Seoul (KR); Dong-Seob LEE, Seoul (KR); Bo Kun PARK, Seoul (KR); Chul Joo YOON, Seoul (KR)

(73) Assignee: CJ LOGISTICS CORPORATION, Seoul (KR)

(21) Appl. No.: 19/136,502

(22) PCT Filed: Dec. 11, 2023
(86) PCT No.: PCT/KR2023/020354

§ 371 Date: Jun. 6, 2025

(30) Foreign Application Priority Data
Dec. 20, 2022 (KR) 10-2022-0179868

(51) Int. Cl. B65G 67/24; B65G 15/12; B65G 21/12; B65G 21/14; B65G 23/44

(52) U.S. Cl. CPC B65G 67/24; B65G 15/12; B65G 21/12; B65G 21/14; B65G 23/44; B65G 2207/28

(57) ABSTRACT

A digging hopper includes a digging plate for moving forward so as to be inserted between a bottom surface of a cargo area and a lower surface of loaded cargo, and a transfer conveyor formed to extend backward from the digging plate, wherein the transfer conveyor can transfer the loaded cargo seated on a transfer surface of the transfer conveyor backward, as the digging plate moves forward and is inserted between the bottom surface of the cargo area and the lower surface of the loaded cargo.

### TECHNICAL FIELD

The present disclosure relates to a digging hopper that can automate an unloading process and a cargo unloading automation method using the same, and in particular to, a technique for automating an unloading process by using a special hopper that can automatically unload cargo stored in a cargo area in bulk units.

### BACKGROUND ART

In domestic and international delivery logistics fields, most technologies for automatically unloading cargo from cargo areas of vehicles have limitations depending on physical properties of the cargo that can be handled. Also, it is difficult to sort and transfer cargo discharged in bulk units to subsequent processes, and there are limitations to general-purpose applications due to installation space issues and level differences between the vehicle cargo areas and docks. In addition, such technologies are not suitable for applications to the domestic delivery logistics environment due to inability for connection with conveyors provided in existing logistics terminals, increased construction costs due to layout changes, high construction costs of robot systems, or the like.

For example, in the prior art for robotic arm-based unloading automation, size and type of cargo that can be unloaded are determined depending on the location and handling characteristics of loaded cargo. In addition, there are no cargo sorting and transfer functions, resulting in many restrictions on connection with subsequent processes.

There is another prior art that adopts a bulk unit unloading method based on a conveyor mounted in a vehicle loading space, but the prior art still has still difficulties in general-purpose applications due to limitations in remodeling the loading space, changing the infrastructure of subsequent processes, or the like.

### DISCLOSURE OF INVENTION

### Technical Problem

The problem that the present disclosure aims to solve is to support automation of unloading process by using a special hopper that can automatically unload cargo loaded in a vehicle cargo area in bulk units.

The present disclosure also aims to provide a highly practical cargo unloading means that can overcome limitations on cargo handling, lack of dock spaces, high infrastructure change costs, etc. and can reflect the purpose of unloading and cargo characteristics so as to adapt to local delivery logistics environments, and a cargo unloading automation method using the same.

The present disclosure is also intended to provide a cargo unloading means which is designed in consideration of compatibility with existing infrastructure and is systemized in conjunction with a telescopic conveyor in operation, thereby enabling direct connection to a subsequent process.

The technical challenges of the present disclosure are not limited to the technical problems mentioned above, and other technical problems not mentioned will be clearly understood by those skilled in the art from the description hereinafter.

### Solution to Problem

A digging hopper according to an embodiment of the present disclosure to solve the above problems may include a digging plate for moving forward so as to be inserted between a bottom surface of a cargo area and a lower surface of loaded cargo, and a transfer conveyor formed to extend backward from the digging plate, wherein the transfer conveyor may transfer the loaded cargo seated on a transfer surface of the transfer conveyor backward, as the digging plate moves forward and is inserted between the bottom surface of the cargo area and the lower surface of the loaded cargo.

In one or more embodiments, the digging hopper may further include one pair of guide free rollers provided between the digging plate and the transfer conveyor.

In one or more embodiments, the digging plate may have an upper surface having upward inclination from front to rear, the upper surface may include at least a first upper surface at a forefront and a second upper surface behind the first upper surface, and upward inclination of the first upper surface may be greater than upward inclination of the second upper surface.

In one or more embodiments, the transfer conveyor may include a plurality of conveyor belts divided in left and right direction and/or in a transfer direction, and at least one of the plurality of conveyor belts may have a conveying speed different from that of an adjacent conveyor belt.

In one or more embodiments, the transfer conveyor may include an inclination transfer conveyor, of which transfer surface forms an upward inclination surface from front to rear.

In one or more embodiments, the transfer conveyor may further include a pitching conveyor between the digging plate and the inclination transfer conveyor, the digging plate and the pitching conveyor each have upward inclination from front to rear, and the upward inclination of the pitching conveyor is smaller than those of the digging plate and the inclination transfer conveyor.

In one or more embodiments, the digging hopper may be provided in front of a telescopic conveyor so as to continuously transfer the loaded cargo to the telescopic conveyor.

In one or more embodiments, for continuous transfer to the telescopic conveyor, the transfer conveyor may include link transfer conveyors on a left side and a right side of a rear end thereof, respectively, and the link transfer conveyors each may have a vertical surface as a transfer surface.

In one or more embodiments, the digging hopper may further includes a rail fixed to a base frame fixed to the telescopic conveyor, and a hopper frame, which is provided so as to move relative to the base frame, and on which the transfer conveyor is provided, wherein the link transfer conveyor may include a belt and a first pulley and a second pulley over which the belt is looped, the first pulley may be coupled to the hopper frame, and the second pulley may be provided so as to move in back and forth directions along the rail.

In one or more embodiments, the digging hopper may further include a hopper frame, which is provided to move relative to the base frame fixed to a telescopic conveyor, and on which the transfer conveyor is provided, and a vertical drive device interposed between the base frame and the hopper frame so as to move the hopper frame relative to the base frame and to raise or lower a front end of the digging hopper.

In one or more embodiments, the vertical drive device may include a first vertical drive device on a left side and a second vertical drive device on a right side in left and right direction, and the first vertical drive device and the second vertical drive device can be controlled so that drive distances are same as or different from each other.

In one or more embodiments, a connection portion between the vertical drive device and the base frame and a connection portion between the vertical drive device and the hopper frame may include two-axis joints, which allow relative rotation around a horizontal shaft and relative rotation around a vertical shaft.

In one or more embodiments, the digging hopper may further include a hopper frame, which is provided to move relative to a base frame fixed to a telescopic conveyor, and on which the transfer conveyor is provided, and a horizontal drive device interposed between the base frame and the hopper frame so as to move the hopper frame relative to the base frame, thereby moving the digging hopper to the left or right with respect to the base frame.

In one or more embodiments, the digging hopper may further include a hopper frame, which is provided to move relative to a base frame fixed to a telescopic conveyor, and on which the transfer conveyor is provided, and a landing gear interposed between a rear end portion of the hopper frame and the bottom surface of the cargo area so as to support the rear end portion of the hopper frame, wherein length of the landing gear, which extends between the rear end portion of the hopper frame and the bottom surface of the cargo area is adjustable.

In one or more embodiments, the digging hopper further may include a shock absorber for elastically supporting a rear surface of the transfer surface so as to alleviate impact applied to the transfer surface of the transfer conveyor.

In one or more embodiments, the transfer conveyor may include a tension pulley for adjusting tension of the transfer conveyor.

In one or more embodiments, the digging plate may include a main plate, a first expansion plate, which is provided on a left side of the main plate and is expandable in the left direction, and a second expansion plate, which is provided on a right side of the main plate and is expandable in the right direction.

In one or more embodiments, the digging hopper may further include a third expansion plate, which is provided on a left side of the transfer conveyor and is expandable in the left direction, and a fourth expansion plate, which is provided on a right side of the transfer conveyor and is expandable in the right direction.

In one or more embodiments, the digging plate may include a main plate, a first expansion plate, which is provided on a left side of the main plate and is expandable in the left direction, and a second expansion plate, which is provided on a right side of the main plate and is expandable in the right direction, the digging hopper may further include a third expansion plate, which is provided on a left side of the transfer conveyor and is expandable in the left direction and a fourth expansion plate, which is provided on a right side of the transfer conveyor and is expandable in the right direction, the first expansion plate and the second expansion plate may be driven by an expansion plate drive device, and the third expansion plate and the fourth expansion plate may be configured to be interlocked with the first expansion plate and the second expansion plate, respectively.

In one or more embodiments, the digging hopper may further include a shock absorber device connected to the digging plate so as to absorb shock caused by external force applied to the digging plate.

According to an embodiment of the present disclosure to solve the above problems, a cargo unloading automation method of unloading loaded cargo uses a digging hopper, which includes a digging plate for moving forward so as to be inserted between a bottom surface of a cargo area and a lower surface of loaded cargo, a transfer conveyor formed to extend backward from the digging plate, and one pair of guide free rollers provided between the digging plate and the transfer conveyor, wherein the transfer conveyor transfers the loaded cargo seated on a transfer surface of the transfer conveyor backward, as the digging plate moves forward and is inserted between the bottom surface of the cargo area and the lower surface of the loaded cargo, and the method may include inserting a rear end of a guide sheet laid between the bottom surface of the cargo area and the lower surface of the loaded cargo through a gap between the one pair of guide free rollers, and transferring the loaded cargo seated on the transfer surface of the transfer conveyor backward, while moving the digging hopper forward.

According to another embodiment of the present disclosure to solve the above problems, a cargo unloading automation method of unloading loaded cargo uses a digging hopper, which includes a digging plate for moving forward so as to be inserted between a bottom surface of a cargo area and a lower surface of loaded cargo, and a transfer conveyor formed to extend backward from the digging plate, wherein the transfer conveyor transfers the loaded cargo seated on a transfer surface of the transfer conveyor backward, as the digging plate moves forward and is inserted between the bottom surface of the cargo area and the lower surface of the loaded cargo, the method may include moving the digging hopper forward until the digging plate is inserted between the bottom surface of the cargo area and the lower surface of the loaded cargo, and carrying out individual position movement while automatically transferring the loaded cargo seated on the transfer surface of the transfer conveyor backward as the digging plate is moved forward so as to be inserted between the bottom surface of the cargo area and the lower surface of the loaded cargo, in which in order to support the automatic transfer, an operator applies external force to some of the loaded cargo by using an auxiliary tool so that the individual position movement is performed from a first position to a displaced second position, wherein the auxiliary tool may include at least one of an adsorption part for adsorbing the loaded cargo and wings capable of holding and pulling the loaded cargo.

The configuration and function of each of these solutions will become more apparent from the detailed contents for implementing the present disclosure described hereinafter based on the accompanying drawings.

### Advantageous Effects of Invention

According to the present disclosure, the digging hopper and the cargo unloading automation method using the same can be flexibly applied to the construction of automated lines in connection with subsequent processes and existing infrastructure to suit the purpose of operation in the logistics industry, especially, in the delivery logistics terminal environment, and can replace work that relies on human resources with automation-based process technology, thereby advantageously saving labor costs, reducing labor intensity in the unloading process and improving work productivity.

In addition, the present disclosure can overcome the disadvantages of the prior art, such as limitations in cargo handling, lack of dock spaces, and high infrastructure change costs, and have the advantage of high practicality since it can reflect unloading purposes and cargo characteristics so as to adapt to local delivery logistics environments.

Furthermore, according to the present disclosure, it is possible to provide the advantage of minimizing impact on physical properties by automatically discharging goods in bulk units without significant limitations on loading patterns, physical property effects, vehicle condition, etc.

Meanwhile, according to the present disclosure, the digging hopper can be systemized in conjunction with the telescopic conveyor in operation and directly connected to subsequent processes through the design in consideration of compatibility with existing infrastructure, thereby exhibiting high usability in the delivery logistics environment and significantly contributing to the spread of unloading automation in the logistics industry.

The effect of present disclosure is not limited to the advantages mentioned above, and other advantages not mentioned will be clearly understood by those skilled in the art from the claims.

### BRIEF DESCRIPTION OF DRAWINGS

FIG. 1 is a view schematically showing overall configuration of cargo unloading automation equipment according to an embodiment of the present disclosure.

FIG. 2 is a view schematically showing a digging hopper according to an embodiment of the present disclosure.

FIG. 3 is a view schematically showing a digging plate of a digging hopper according to an embodiment of the present disclosure.

FIG. 4 is a view schematically showing a link transfer conveyor of a digging hopper according to an embodiment of the present disclosure.

FIG. 5 and FIG. 6 are views schematically showing a vertical drive device and a horizontal drive device in a digging hopper according to an embodiment of the present disclosure, respectively.

FIG. 7 is a view schematically showing a shock absorber and a tension pulley for tension control in a digging hopper according to an embodiment of the present disclosure.

FIG. 8 is a view schematically showing an expansion plate of a digging hopper according to an embodiment of the present disclosure.

FIG. 9 is a view schematically showing an expansion plate drive device and a shock absorber device in a digging hopper according to an embodiment of the present disclosure, and

FIG. 10 is a view schematically showing an auxiliary tool of a cargo unloading support device according to an embodiment of the present disclosure.

### BEST MODE FOR CARRYING OUT THE INVENTION

The features and advantages of the present disclosure and methods for achieving them will become more apparent by referring to the embodiments described in detail below along with the accompanying drawings. However, the present disclosure is not limited to the embodiments disclosed below and will be implemented in various different forms. These embodiments are merely provided to fully inform those skilled in the art of the scope of the present disclosure, and the present disclosure is defined by the claims. Like reference numerals refer to like elements throughout the description.

It will be understood that when an element is referred to as being “connected to” or “coupled to” another element, it may be directly connected or coupled to the other element, or an intervening element may exist. In contrast, it will be understood that when an element is referred to as being “directly connected to” or “directly coupled to” another element, there is no intervening element. The expression “and/or” includes any combination of one or more of the items mentioned.

The terms used herein is intended to describe embodiments and are not intended to limit the present disclosure. Singular forms herein are intended to include plural forms unless the context clearly indicates otherwise. The terms “comprises,” and/or “comprising,” or the like used herein specify the presence of stated features, steps, operations, and/or elements but do not preclude the probability of presence or addition of one or more other features, steps, operations, and/or elements.

Terms, such as first and/or second, may be used to describe various elements, but the elements are not limited by these terms. The terms are used merely for the purpose of distinguishing one element from other elements. Therefore, of course, a first component mentioned below may also be a second component within the technical idea of present disclosure.

As used herein, terms related to direction such as “front,” “rear,” “left,” “right,” “vertical,” and “horizontal” are used in a relative sense for convenience of explanation, and may vary depending on the direction of observation.

Unless otherwise defined, all terms used herein, including technical or scientific terms, have the same meanings as terms generally understood by those of ordinary skill in the art to which the present disclosure pertains. Terms defined in a generally used dictionary are not interpreted to have ideal or excessively formal meanings unless clearly defined herein.

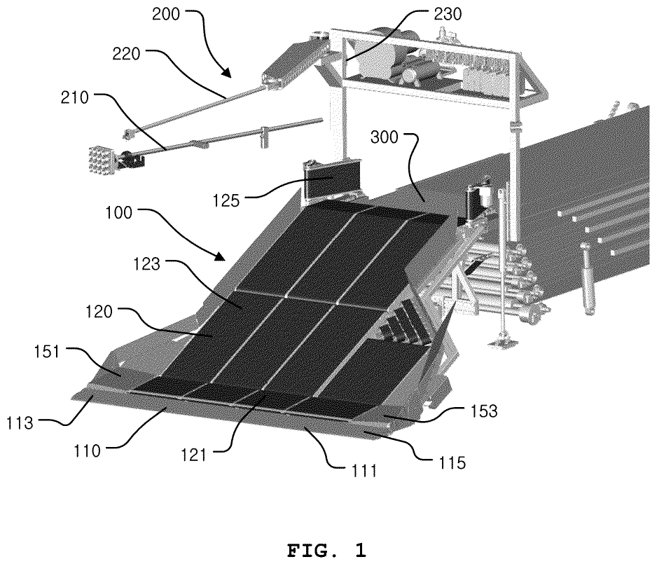

FIG. 1 is a view schematically showing overall configuration of cargo unloading automation equipment according to an embodiment of the present disclosure.

The cargo unloading automation equipment may include a digging hopper 100 that can automate cargo unloading and a cargo unloading support device 200 that can support automation of cargo unloading.

The digging hopper 100 is a component that enters a cargo area of a vehicle and moves under a bottom of loaded cargo so that the loaded cargo can be automatically discharged, and is a cargo discharge device that allows the loaded cargo to be transferred in bulk units. The digging hopper 100 is coupled to a front end of a telescopic conveyor 300, which can extend/retract, so as to move forward as the telescopic conveyor 300 extends, thereby entering the vehicle cargo area and automatically discharging the loaded cargo. The digging hopper 100 provided at the front of the telescopic conveyor 300 can unload the loaded cargo from the vehicle cargo area and transfer the unloaded cargo to the telescopic conveyor 300 at the rear.

The cargo unloading support device 200 can support process operators to handle the loaded cargo in individual units or in bulk units. The cargo unloading support device 200 may include an auxiliary tool 210. Additionally, the cargo unloading support device 200 may include a guide arm 220 and/or a weight compensation device 230.

The auxiliary tool 210 may be a manual tool used by an operator so as to support automated unloading operation of the digging hopper 100. The auxiliary tool 210 can be handled by the operator so as to come into contact with the loaded cargo and apply an external force to the loaded cargo, thereby moving the loaded cargo.

The weight compensation device 230 can compensate for self-weight of the tool 210 so as to reduce workload of an operator. The weight compensation device 230 may include a wire for suspending the tool 210 and a pulley device for applying tension to the wire. In one or more embodiments, the pulley device may be a composite pulley device including a fixed pulley around which a wire is wound, a movable pulley, and a weight for generating tension.

The guide arm 220 can support a portion of the wire between the auxiliary tool 210 and the pulley device. The guide arm 220 can expand an operating radius of the auxiliary tool 210. To this end, the guide arm 220 can be designed to have a length appropriate for an operation space within the cargo area.

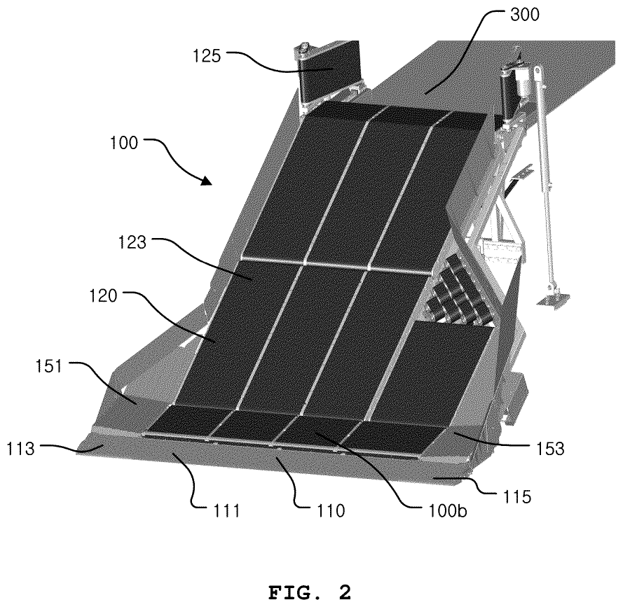

FIG. 2 is a view schematically showing a digging hopper 100 according to an embodiment of the present disclosure.

The digging hopper 100 may include a digging plate 110 and a transfer conveyor 120.

The digging plate 110 can be moved forward to be inserted between a bottom surface of the cargo area and a lower surface of the loaded cargo. The transfer conveyor 120 may be a belt-type conveyor device including a conveyor belt. The transfer conveyor 120 may be formed to extend rearward from the digging plate 110. The transfer conveyor 120 can transfer the loaded cargo seated on a transfer surface of the transfer conveyor 120 backward as the digging plate 110 moves forward and is inserted between the bottom surface of the cargo area and the lower surface of the loaded cargo.

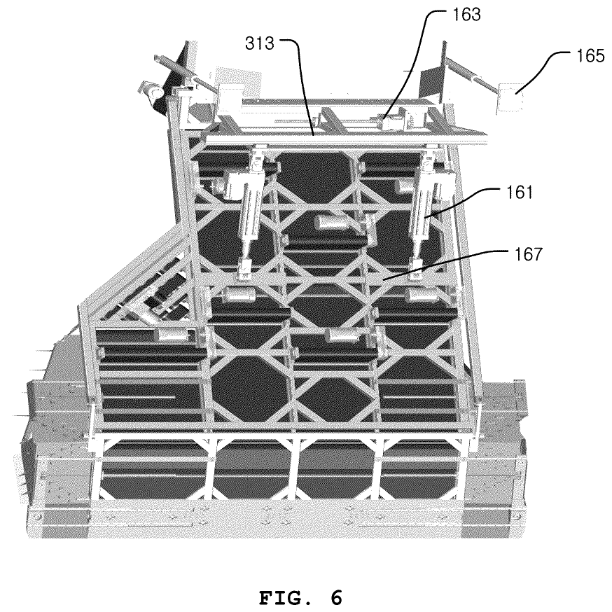

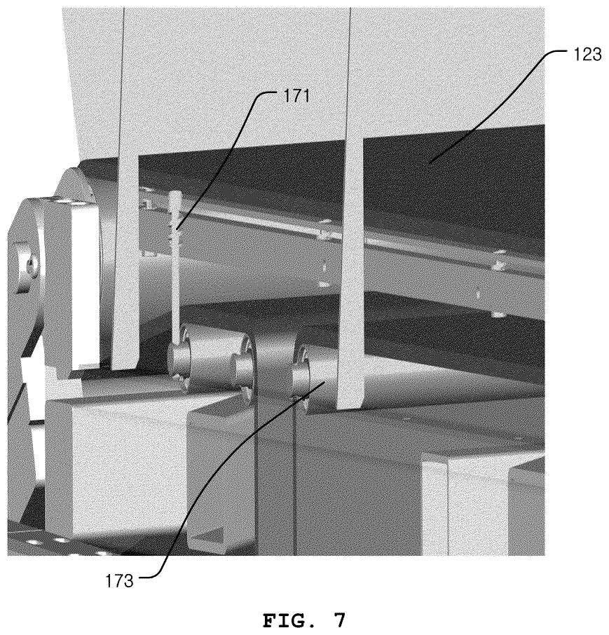

In one or more embodiments, the digging hopper 100 may include a hopper frame 167 (see FIG. 6). The hopper frame 167 may be coupled to a base frame 313 fixed to a front end of the telescopic conveyor 300 so that the hopper frame 167 may move relative to the base frame 313 (see FIG. 6 and FIG. 7). The transfer conveyor 120 may be provided on the hopper frame. The digging plate 110 may be coupled to the hopper frame 167 so that a gap is provided in back and forth directions with respect to the hopper frame 167. Therefore, when the telescopic conveyor 300 extends, the base frame 313 can move forward, and accordingly, the hopper frame 167 and the transfer conveyor 120 can move forward, and the digging plate 110 can also move forward.

The digging plate 110 may have an upper surface with upward inclination from front to rear. The upper surface may include at least a first upper surface at a forefront and a second upper surface behind the first upper surface. Upward inclination of the first upper surface may be greater than upward inclination of the second upper surface. If the upward inclination of the first upper surface at the forefront is small, a frontmost portion of the digging plate 110 becomes sharper than necessary, so that when the digging plate 110 moves forward, the frontmost portion of the digging plate 110 may get stuck in the cargo or leave a mark on the bottom of the cargo. Therefore, the upward inclination of the first upper surface is limited.

In one or more embodiments, the transfer conveyor 120 may include an inclination transfer conveyor 123. In addition, the transfer conveyor may include a pitching conveyor 121 between the digging plate 110 and the inclination transfer conveyor 123. In addition, the transfer conveyor 120 may include link transfer conveyors 125. In an embodiment where the transfer conveyor 120 includes all of these, the inclination transfer conveyor 123 may be disposed at the rear of the pitching conveyor 121, and the link transfer conveyors 125 may be disposed on left and right sides of a rear end of the inclination transfer conveyor 123.

The pitching conveyor 121 can pull out the cargo, which comes up on the digging plate 110 in an opposite direction (backward direction) of a hopper 100 entry direction (forward direction) so that the cargo can be discharged based on the conveyor belt. Additionally, in order to provide sufficient friction, the belt of the pitching conveyor 121 can be designed as a non-slip belt. The pitching conveyor 121 may include a plurality of conveyor belts divided in left and right direction, wherein at least one of the plurality of conveyor belts may have a transfer speed different from that of an adjacent conveyor belt. By imparting a transfer speed difference, a discharge amount can be adjusted based on the transfer speed difference.

In one or more embodiments, the pitching conveyor 121 may have an upward inclination smaller than those of the digging plate 110 and the inclination transfer conveyor 123. Typically, cargo is loaded inside the cargo area to a height that almost touches ceiling. If the digging hopper 100 is designed so as to be connected directly from the digging plate 110 to the inclination transfer conveyor 123 without the pitching conveyor 121, or if the upward inclination of the pitching conveyor 121 is increased, a problem may occur where the cargo becomes caught under the ceiling, before the digging plate 110 moves underneath the bottom of the cargo and the cargo collapses. Therefore, in order to prevent this problem, the upward inclination of the pitching conveyor 121 may be reduced.

The transfer conveyor 120, especially, the transfer surface of the inclination transfer conveyor 123 may form an upward inclination surface from front to rear. By providing an upward inclination, the loaded cargo is not collapsed all at once toward an empty space at the back, but is induced to collapse one after another while being supported from other cargo in front, so that it is possible to minimize damage to the cargo, drop shock that may be applied to the transfer conveyor 120, and resulting damage. The inclination transfer conveyor 123 enables transfer of the cargo discharged in bulk units through an inclination section within the hopper 100. The inclination transfer conveyor 123 may include a plurality of conveyor belts divided in left and right direction and/or in transfer direction so that a discharge amount can be adjusted according to a volume load of a subsequent process. At least one of the plurality of conveyor belts may have a transfer speed different from that of an adjacent conveyor belt.

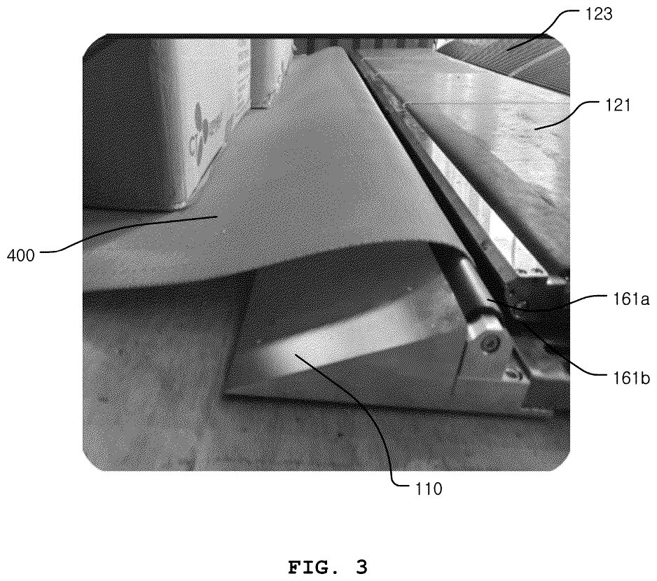

FIG. 3 is a view schematically showing a digging plate 110 of a digging hopper 100 according to an embodiment of the present disclosure.

The digging plate 110 is structured so that when the digging hopper 100 moves forward, the digging plate 110 is inserted into a slight gap between lower surfaces of goods at a lowest position among goods stacked in multiple stages and a bottom surface of a vehicle cargo area, so that the goods can climb onto the digging plate 110.

As mentioned above, in order to minimize the load caused when the digging plate 110 is inserted into the gap between lower ends of the goods and the bottom surface of the cargo area and to minimize damage to the goods, the digging plate 110 may have a special structure so as to be bent in multiple stages and to have a sufficiently fine thickness at a front tip portion. It is possible to provide balls that can rotate in all directions at appropriate positions on a lower surface of the digging plate 110, which comes into contact with the bottom surface of the cargo area, thereby reducing friction.

If necessary, depending on vehicle conditions and operating properties, a detachable guide sheet 400 may be placed on the bottom of the cargo area, that is, between the bottom surface of the cargo area and the lower surface of the loaded cargo. By laying the guide sheet 400 under the cargo and guiding the digging plate 110 to be inserted under the guide sheet 400, the digging plate 110 is guided to be naturally positioned under the cargo. In order to extend a rear end of the guide sheet 400 beyond the digging plate 110, one pair of non-driven guide free rollers 161a, 161b may be provided between the digging plate 110 and the transfer conveyor 120.

After moving the digging hopper 100 forward so that the digging hopper 100 enters an appropriate position inside the vehicle cargo area, the rear end of the guide sheet 400, which is already laid between the bottom surface of the cargo area and the lower surface of the loaded cargo, is inserted through the gap between one pair of guide free rollers 161a, 161b. Then, while continuously moving the digging hopper 100 forward, the loaded cargo is induced to collapse and settle on the transfer surface of the transfer conveyor 120, so that the cargo placed on the transfer surface is transferred backward by the transfer conveyor 120.

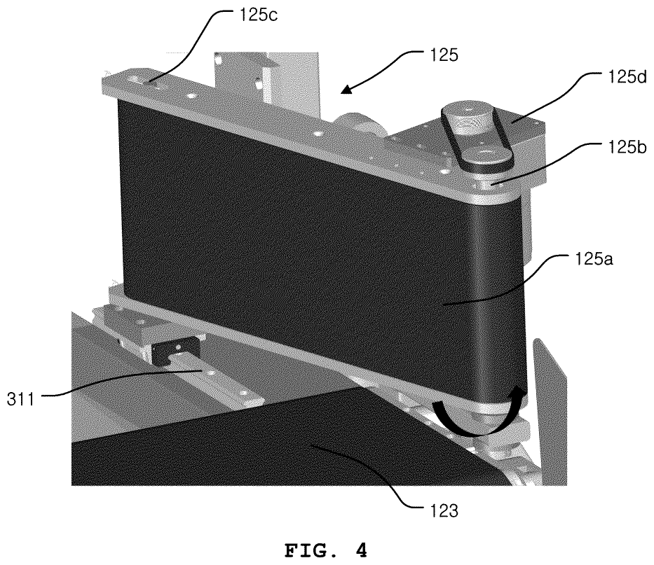

FIG. 4 is a view schematically showing a link transfer conveyor 125 of a digging hopper 100 according to an embodiment of the present disclosure.

A link transfer conveyor 125 for continuous transfer between an existing telescopic conveyor 300 installed in a logistics terminal and the digging hopper 100 can transfer bulk unit cargo discharged through an inclination transfer conveyor 123 to the telescopic conveyor 300 for a subsequent process. In order to minimize a load during the continuous transfer and prevent cargo from escaping, which may occur because width of the hopper 100 is wider than width of the telescopic conveyor 300, link transfer conveyors 125 with vertical drive shafts may be provided on left and right sides of a rear end of an inclination transfer conveyor 123. Therefore, transfer surfaces of the link transfer conveyors 125 can form vertical surfaces.

The link transfer conveyor 125 may include a belt 125a, and a first pulley 125b and a second pulley 125c around which the belt 125a is provided. As described hereinafter, the digging hopper 100 is designed to be horizontally movable left and right. Therefore, the first pulley 125b is rotatably coupled to a hopper frame 167 so that the link transfer conveyor 125 can be linked to a change in position of the digging hopper 100. In addition, the second pulley 125c may be provided to move in forward and backward directions along a rail 311 fixed to a base frame 313. For example, a linear motion LM device may be applied so that a block on which the second pulley 125c is rotatably fixed can be configured to move linearly along the rail 311. The first pulley 125b may be driven by a motor 125d.

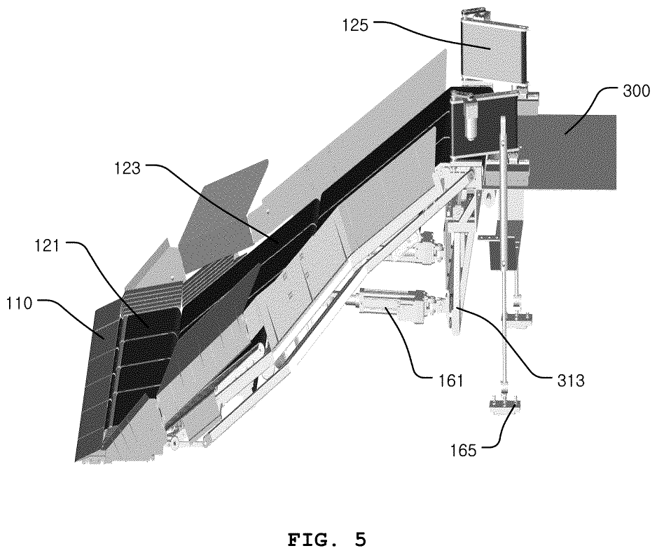

FIG. 5 and FIG. 6 are views schematically showing a vertical drive device 161 and a horizontal drive device 163 in a digging hopper 100 according to an embodiment of the present disclosure, respectively.

In one or more embodiments, the digging hopper 100 may include a vertical drive device 161. The vertical drive device 161 may be interposed between a base frame 313 and a hopper frame 167 so as to move the hopper frame 167 relative to the base frame 313, thereby raising or lowering a front end of the digging hopper 100. The vertical drive device 161 may be configured as a cylinder-based drive device.

In one or more embodiments, the vertical drive device 161 may include a first vertical drive device on the left and a second vertical drive device on the right in the left and right direction, and the first vertical drive device and the second vertical drive device may be controlled so that drive distances thereof become same as or different from each other. By designing the first vertical drive device and the second vertical drive device with a dual cylinder configuration, when an angle change in left and right entry direction is required in addition to up/down adjustment, piston travel distances may be differentiated so as to allow fine angle adjustment of 10 degrees or less, thereby enabling flexible response to cargo area entry tolerances.

In one or more embodiments, a connection portion between the vertical drive device 161 and the base frame 313 and a connection portion between the vertical drive device 161 and the hopper frame 167 include two-axis joints, which allow relative rotation around a horizontal shaft and relative rotation around a vertical shaft. By designing the vertical drive device 161 with the two-axis joint structure, it is possible to reduce a load on a head and to enable position adjustment, when direction of force is changed vertically during piston movement of the cylinder-based vertical drive device 161.

Additionally, in one or more embodiments, the digging hopper 100 may include a horizontal drive device 163. The horizontal drive device 163 may be provided between the base frame 313 and the hopper frame 167 and move the digging hopper 100 to the left or right with respect to the base frame 313 by moving the hopper frame 167 relative to the base frame 313. The horizontal drive device 163 may be configured as a screw-type shaft-based drive device. By connecting a screw-type shaft to a motor rotating body, an LM mount of a shaft attached to the hopper frame 167 can be designed to operate while moving horizontally when a motor rotates.

Additionally, the digging hopper 100 may include a landing gear interposed between a rear end portion of the hopper frame 167 and the bottom surface of the cargo area so as to support the rear end portion of the hopper frame 167. It is possible to adjust length of the landing gear 165, which extends between the rear end portion of the hopper frame 167 and the bottom surface of the cargo area.

FIG. 7 is a view schematically showing a shock absorber and a tension pulley for tension control in a digging hopper 100 according to an embodiment of the present disclosure.

In one or more embodiments, a small shock absorber 171 for elastically supporting a rear surface of a transfer surface of a belt (the other side of the belt, when it is assumed that the transfer surface of two side surfaces of the belt is one surface, on the basis of thickness of the belt) may be provided on the inside of an inclination transfer conveyor 123 in order to alleviate impact of falling cargo. In addition, a tension pulley 173, which can adjust tension based on spring inertia, can be provided to a relieve tension load due to weight eccentricity of cargo and impact of falling objects.

In addition, a small shock absorber for elastically supporting the rear surface of the transfer surface of the belt may be also provided on the inside of a pitching conveyor 121 in order to alleviate impact of falling cargo during discharge.

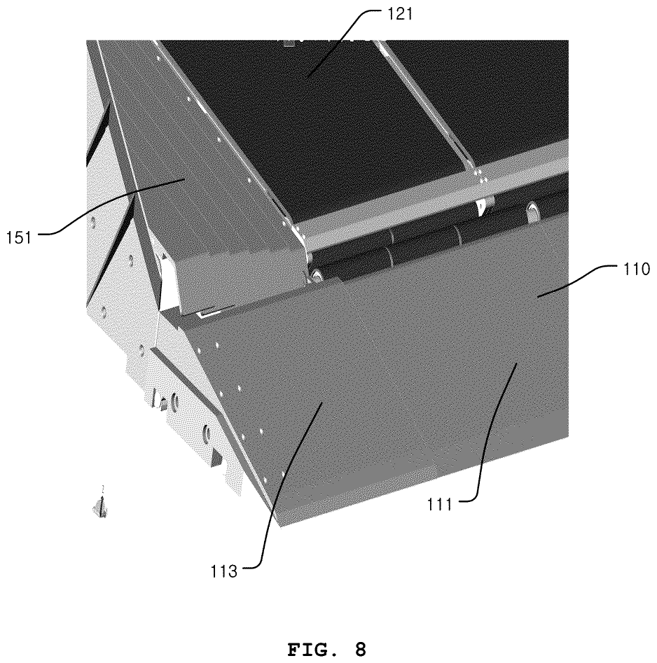

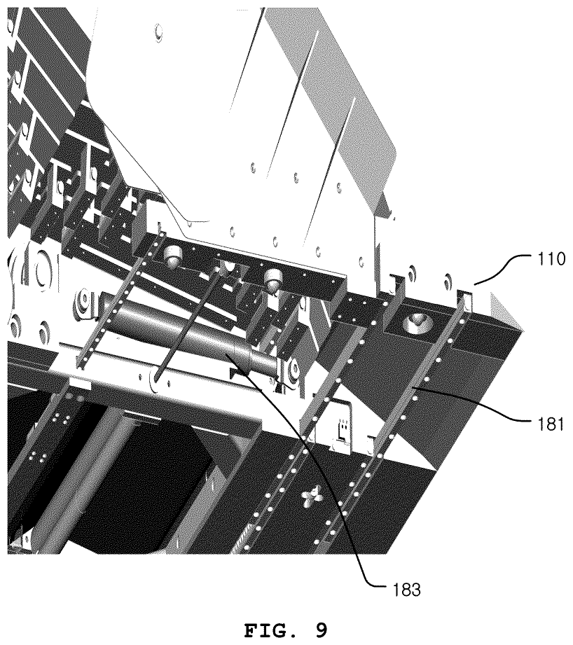

FIG. 8 is a view schematically showing an expansion plate of a digging hopper 100 according to an embodiment of the present disclosure, and FIG. 9 is a view schematically showing an expansion plate drive device 181 and a shock absorber device 183.

In one or more embodiments, a digging plate 110 includes a main plate 111, a first expansion plate 113, which is provided on a left side of the main plate 111 and is expandable in the left direction, and a second expansion plate 115, which is provided on a right side of the main plate 111 and is expandable in the right direction.

In addition, the digging hopper 100 may include a third expansion plate 151, which is provided on a left side of a transfer conveyor 120 and is expandable in the left direction, and a fourth expansion plate 153, which is provided on a right side of the transfer conveyor 120 and is expandable in the right direction.

The first expansion plate 113 and the second expansion plate 115 are driven by an expansion plate drive device 181, and the third expansion plate 151 and the fourth expansion plate 153 are configured to be interlocked with the first expansion plate 113 and the second expansion plate 115, respectively.

A vehicle cargo area has width, which varies depending on vehicle type (wing-top, container, specially equipped vehicle, etc.). In order to resolve tolerances depending on degree of alignment when entering a hopper 100, the digging plate 110 is designed to be expandable to left and right side surfaces inside the cargo area. In order to perform the horizontal left and right expansion function, the expansion plate drive device 181 can be designed to be driven by an LM linear motion guide and an air cylinder inside the digging plate 110. In addition, the third expansion plate 151 and the fourth expansion plate 153 may also be designed to be connected to the first expansion plate 113 and the second expansion plate 115, respectively, on a principle similar to the bellows method so as to be synchronized during expansion.

The digging hopper 100 may include a shock absorber device 183. The shock absorber device 183 is connected to the digging plate 110 so as to absorb shock caused by external force applied to the digging plate 110. In one or more embodiments, in order to minimize damage to a bottom surface and fine irregularities caused when the digging plate 110 comes into contact with the bottom surface, an air cylinder type shock absorber device 183 may be interposed between the digging plate 110 and the hopper frame so as to absorb shock applied to the digging plate 110.

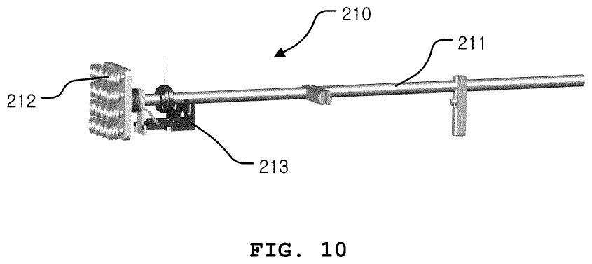

FIG. 10 is a view schematically showing an auxiliary tool 210 of a cargo unloading support device 200 according to an embodiment of the present disclosure.

The auxiliary tool 210 may include a tool body 211 that extends long in the longitudinal direction. In addition, the auxiliary tool 210 may include an adsorption part 212 which is formed at one end of the tool body 211 and adsorbs loaded cargo. An operator can move the loaded cargo by moving the tool body 211 while adsorbing the loaded cargo to be moved with the adsorption part 212.

Furthermore, the auxiliary tool 210 may include wings 213 that can hold and pull the loaded cargo. The wings 213 can be used not only for pulling, but also for pushing the loaded cargo forward or to the side when necessary, and the present disclosure does not exclude such uses of the wings 213. When the loaded cargo is not suitable for adsorption with the adsorption part 212, the loaded cargo can be moved by hooking the wings 213 to the loaded cargo and pulling the wings 213 (sometimes pushing the wings 213 forward or to the side). Herein, the meaning of “hooking” does not mean a strong coupling relationship to an extent that the loaded cargo does not separate from the wings 213, but means a simple contact relationship more suitable for pulling or pushing. Herein, the meaning of “more suitable” is that it is more effective to pull or push the loaded cargo forward or to the side by using the wings 213 than to pull or push the loaded cargo forward or to the side with, for example, the tool body 211 in a rod shape without the wings 213. As the digging plate 110 moves forward and is inserted between a bottom surface of a cargo area and a lower surface of the loaded cargo, the loaded cargo placed on the transfer surface of the transfer conveyor 120 is automatically transferred to the rear, and at the same time, an operator can apply external force to at least some of the loaded cargo by using the auxiliary tool 210 so as to support the automatic transfer. Therefore, individual position movement can be performed from a first position to a displaced second position.

In an embodiment of present disclosure, by using the digging hopper 100, products loaded in a vehicle's cargo area can be automatically discharged in bulk units to a subsequent process as the hopper 100 moves forward, so that unloading automation can be implemented. In particular, the digging hopper 100 can be applied to cargo areas of various types of vehicles and can handle various types of products in bulk units, so it can be applied to the delivery terminal unloading process with high labor intensity.

For example, when a vehicle to be unloaded docks at an unloading dock in a delivery terminal, a telescopic conveyor is extended in order to move a digging hopper 100 of cargo unloading automation equipment to the front of a cargo area, and then unloading process can be started by sweeping loaded products into the hopper 100 until a minimum entry space is secured inside the cargo area. Herein, if a guide sheet 400 is provided inside the cargo area, the digging hopper 100 can be moved forward after the guide sheet 400 is coupled to the digging hopper 100. If a minimum space for the digging hopper 100 to enter the cargo area is secured, the digging hopper 100 can enter the cargo area in a state, where the digging hopper 100 is raised by a level difference between the dock and the vehicle cargo area.

In basic unloading process, items piled up at the top are handled with an auxiliary tool 210 in order to minimize product damage. As the digging hopper 100 moves forward, items in the middle and on the bottom are automatically discharged by the pitching conveyor 121 and the inclination transfer conveyor 123 of the digging hopper 100. The hopper 100 can move forward as expansion plates 113, 115, 151, 153 adhere to wall surfaces of the cargo area so as to ensure that no cargo remains on the left and right sides.

In addition, the hopper 100 may be changed in position through up and down vertical operations and left and right horizontal operations, depending on conditions of the cargo or docking errors. Additionally, since a weight load applied to the hopper 100 increases during unloading by the length of the telescopic conveyor 300, the landing gear 165 for cargo handling weight distribution and load minimization is provided on the digging hopper 100 at the rear end, wherein height of the landing gear 165 is automatically determined according to the bottom surface of the cargo area, so that the hopper 100 can be seated without interference when moving forward.

The hopper 100 may be equipped with the shock absorber so as to relieve the impact of falling products. In addition, in order to control quantity of cargo transferred at once and to resolve delays during continuous transfers, the transfer conveyor 120 may be designed to enable quantity control using speed deviation by dividing the transfer conveyor 120 into, for example, three horizontal parts or two vertical parts.

If all the cargo within the vehicle cargo area has been unloaded, the telescopic conveyor 300 is driven to retract by extended length so that the digging hopper 100 which moved forward returns to its starting position. Then, the guide sheet 400 coupled to the digging hopper 100 is released, and the digging hopper 100 maintains a standby state until a next vehicle

The cargo unloading automation equipment based on automatic cargo discharge according to the embodiments of the present disclosure can alleviate the labor intensity of unloading operators in delivery terminals, and is expected to be highly utilized in the delivery logistics environment where man-power supply is difficult, since the unloading process is automated, increasing productivity per operator compared to existing manual unloading systems.

As described hereinabove, according to present disclosure, it is possible to support automation of unloading process at a delivery logistics terminal by using a special hopper that can automatically discharge cargo stored in a vehicle cargo area in bulk units. In particular, delivery items can be handled universally depending the characteristics (size, packaging materials, conditions, etc.) thereof. In addition, it is possible to save investment costs in logistics facilities, reduce the labor intensity of unloading operators, and establish foundation for unloading process automation through flexible applications to existing infrastructure conveyors, dock environments, etc.

The present disclosure also enables the automatic discharge of large amounts of cargo by utilizing a structurally functionalized special hopper that allows automatic discharge of cargo by being inserted under the bottom of the cargo stored in a cargo area. Therefore, the present disclosure has the advantage of securing flexibility in mechanical unloading operations by enabling automatic discharge of goods in bulk units without major restrictions in handling various properties of the goods stacked in a cargo area to suit the delivery logistics environment. In addition, the special hopper according to the present disclosure is designed to be linked to the infrastructure facilities in the existing logistics terminals and to be combined with telescopic conveyors which are expandable/retractable, so that goods can be safely transferred to subsequent processes. Therefore, it is possible to establish unloading automation equipment that can safely transfer cargo to subsequent processes.

The present disclosure can also safely handle cargo inside a cargo area of a vehicle based on a special hopper, which is designed so that the hopper can discharge the cargo in bulk units by lifting the cargo from below and can safely handle the cargo in the vehicle cargo area by adding the guide sheet, which is placed on the bottom surface of the vehicle cargo area so that the hopper can be positioned under the sheet, as necessary depending on the conditions of the vehicle floor, weight of cargo, etc.

This type of unloading automation technology such as the present disclosure has never been used in the domestic logistics industry, especially in the unloading process at delivery terminals or loading/unloading process in general logistics centers. Therefore, the present disclosure can be said to be a new concept of unloading automation system that is differentiated from conventional technologies such as robot arm-based unloading automation systems and cargo area-fixed type special conveyor systems.

1. A digging hopper, comprising:
a digging plate for moving forward so as to be inserted between a bottom surface of a cargo area and a lower surface of loaded cargo; and
a transfer conveyor formed to extend backward from the digging plate, wherein the transfer conveyor transfers the loaded cargo seated on a transfer surface of the transfer conveyor backward, as the digging plate moves forward and is inserted between the bottom surface of the cargo area and the lower surface of the loaded cargo.

2. The digging hopper according to claim 1, wherein the digging hopper further includes one pair of guide free rollers provided between the digging plate and the transfer conveyor.

3. The digging hopper according to claim 1, wherein
the digging plate has an upper surface having upward inclination from front to rear,
the upper surface includes at least a first upper surface at a forefront and a second upper surface behind the first upper surface, and
upward inclination of the first upper surface is greater than upward inclination of the second upper surface.

4. The digging hopper according to claim 1, wherein
the transfer conveyor includes a plurality of conveyor belts divided in left and right direction and/or in transfer direction, and
at least one of the plurality of conveyor belts has a conveying speed different from that of an adjacent conveyor belt.

5. The digging hopper according to claim 1, wherein
the transfer conveyor includes an inclination transfer conveyor, of which transfer surface forms upward inclination surface from front to rear.

6. The digging hopper according to claim 5, wherein
the transfer conveyor further includes a pitching conveyor between the digging plate and the inclination transfer conveyor,
the digging plate and the pitching conveyor each have upward inclination from front to rear, and
the upward inclination of the pitching conveyor is smaller than those of the digging plate and the inclination transfer conveyor.

7. The digging hopper according to claim 1, wherein
the digging hopper is provided in front of a telescopic conveyor so as to continuously transfer the loaded cargo to the telescopic conveyor.

8. The digging hopper according to claim 7, wherein
for continuous transfer to the telescopic conveyor, the transfer conveyor includes link transfer conveyors on a left side and a right side of a rear end, respectively, and
the link transfer conveyors each have a vertical surface as a transfer surface.

9. The digging hopper according to claim 8, further comprising:
a rail fixed to a base frame fixed to the telescopic conveyor; and
a hopper frame, which is coupled to the base frame so as to move relative to the base frame, and on which the transfer conveyor is provided,
wherein the link transfer conveyor includes a belt and a first pulley and a second pulley over which the belt is looped,
the first pulley is coupled to the hopper frame, and
the second pulley is provided so as to move in back and forth directions along the rail.

10. The digging hopper according to claim 1, further comprising:
a hopper frame, which is coupled to a base frame fixed to a telescopic conveyor so as to move relative to the base frame, and on which the transfer conveyor is provided; and
a vertical drive device interposed between the base frame and the hopper frame so as to move the hopper frame relative to the base frame and to raise or lower a front end of the digging hopper.

11. The digging hopper according to claim 10, wherein
the vertical drive device includes a first vertical drive device on a left side and a second vertical drive device on a right side in left and right direction, and
the first vertical drive device and the second vertical drive device can be controlled so that drive distances are same as or different from each other.

12. The digging hopper according to claim 10, wherein
a connection portion between the vertical drive device and the base frame and a connection portion between the vertical drive device and the hopper frame include two-axis joints, which allow up and down relative rotation around left and right horizontal shafts as rotation shafts and left and right relative rotation around up and down vertical shafts as rotation shafts.

13. The digging hopper according to claim 1, further comprising:
a hopper frame, which is coupled to a base frame fixed to a telescopic conveyor so as to move relative to the base frame, and on which the transfer conveyor is provided; and
a horizontal drive device interposed between the base frame and the hopper frame so as to move the hopper frame relative to the base frame and to move the digging hopper to the left or right with respect to the base frame.

14. The digging hopper according to claim 1, further comprising:
a hopper frame, which is coupled to a base frame fixed to a telescopic conveyor so as to move relative to the base frame, and on which the transfer conveyor is provided; and
a landing gear interposed between a rear end portion of the hopper frame and the bottom surface of the cargo area so as to support the rear end portion of the hopper frame,
wherein length of the landing gear, which extends between the rear end portion of the hopper frame and the bottom surface of the cargo area is adjustable.

15. The digging hopper according to claim 1, further including a shock absorber for elastically supporting a rear surface of the transfer surface so as to alleviate impact applied to the transfer surface of the transfer conveyor.

16. The digging hopper according to claim 1, wherein the transfer conveyor includes a tension pulley for adjusting tension of the transfer conveyor.

17. The digging hopper according to claim 1, wherein the digging plate includes a main plate, a first expansion plate, which is provided on a left side of the main plate and is expandable in the left direction, and a second expansion plate, which is provided on a right side of the main plate and is expandable in the right direction.

18. The digging hopper according to claim 1, further comprising:
a third expansion plate, which is provided on a left side of the transfer conveyor and is expandable in the left direction; and
a fourth expansion plate, which is provided on a right side of the transfer conveyor and is expandable in the right direction.

19. The digging hopper according to claim 1, wherein
the digging plate includes a main plate, a first expansion plate, which is provided on a left side of the main plate and is expandable in the left direction, and a second expansion plate, which is provided on a right side of the main plate and is expandable in the right direction,
the digging hopper further includes a third expansion plate, which is provided on a left side of the transfer conveyor and is expandable in the left direction, and a fourth expansion plate, which is provided on a right side of the transfer conveyor and is expandable in the right direction,
the first expansion plate and the second expansion plate are driven by an expansion plate drive device, and
the third expansion plate and the fourth expansion plate are configured to be interlocked with the first expansion plate and the second expansion plate, respectively.

20. The digging hopper according to claim 1, further including a shock absorber device connected to the digging plate so as to absorb shock caused by external force applied to the digging plate.

21. The digging hopper according to claim 1, wherein the digging hopper is provided so as to be coupled to a telescopic conveyor in front of the telescopic conveyor, so that the digging hopper moves forward as the telescopic conveyor extends forward.

22. A cargo unloading automation method of unloading loaded cargo by using a digging hopper, which includes a digging plate for moving forward so as to be inserted between a bottom surface of a cargo area and a lower surface of loaded cargo, a transfer conveyor formed to extend backward from the digging plate, and one pair of guide free rollers provided between the digging plate and the transfer conveyor,
wherein the transfer conveyor transfers the loaded cargo seated on a transfer surface of the transfer conveyor backward, as the digging plate moves forward and is inserted between the bottom surface of the cargo area and the lower surface of the loaded cargo, the method comprising:
inserting a rear end of a guide sheet laid between the bottom surface of the cargo area and the lower surface of the loaded cargo through a gap between the one pair of guide free rollers; and
transferring the loaded cargo seated on the transfer surface of the transfer conveyor backward, while moving the digging hopper forward.

23. A cargo unloading automation method of unloading loaded cargo by using a digging hopper, which includes a digging plate for moving forward so as to be inserted between a bottom surface of a cargo area and a lower surface of loaded cargo, and a transfer conveyor formed to extend backward from the digging plate, wherein the transfer conveyor transfers the loaded cargo seated on a transfer surface of the transfer conveyor backward, as the digging plate moves forward and is inserted between the bottom surface of the cargo area and the lower surface of the loaded cargo, the method comprising:
moving the digging hopper forward until the digging plate is inserted between the bottom surface of the cargo area and the lower surface of the loaded cargo; and
carrying out individual position movement while automatically transferring the loaded cargo seated on the transfer surface of the transfer conveyor backward as the digging hopper is moved forward so that the digging plate is inserted between the bottom surface of the cargo area and the lower surface of the loaded cargo, in which in order to support the automatic transfer, an operator applies external force to at least some of the loaded cargo by using an auxiliary tool so that the individual position movement is performed from a first position to a displaced second position,
wherein the auxiliary tool includes at least one of an adsorption part for adsorbing the loaded cargo and wings capable of holding and pulling the loaded cargo.
